(19) United States
(12) Patent Application Publication
(10) Pub. No.: US 2013/0059542 A1
(43) Pub. Date: Mar. 7, 2013

(54) INFORMATION PROCESSING APPARATUS, INFORMATION PROCESSING SYSTEM, INFORMATION PROCESSING METHOD, AND TANGIBLE RECORDING MEDIUM RECORDING INFORMATION PROCESSING PROGRAM

(71) Applicant: Takao SHIMIZU, Kyoto (JP)

(72) Inventor: Takao SHIMIZU, Kyoto (JP)

(73) Assignee: NINTENDO CO., LTD., Kyoto (JP)

(21) Appl. No.: 13/290,349

(22) Filed: Nov. 7, 2011

(30) Foreign Application Priority Data
Sep. 5, 2011 (JP) 2011-193003

(51) Int. Cl. H04B 17/00

(52) U.S. Cl. 455/67.11

(57) ABSTRACT

An example information processing apparatus which is portable is provided that includes a zone identifying unit which identifies a zone where the information processing apparatus is located, a reception status measurement unit which measures a reception status of a signal from at least one transmitter in the zone identified by the zone identifying unit, a transmitter identifying unit which identifies the transmitter as a source of the signal in which the reception status corresponds to a predetermined condition, and a processing unit which executes a predetermined processing according to the transmitter identified by the transmitter identifying unit.

This application is based upon and claims the benefit of priority of the prior Japanese Patent Application No. JP2011-193003, filed on Sep. 5, 2011, the entire contents of which are incorporated herein by reference.

### FIELD

This disclosure relates to an information processing apparatus, an information processing system, an information processing method, and a tangible recording medium recording an information processing program for detecting a transmitter, and executing processing according to the detected transmitter.

### BACKGROUND AND SUMMARY

Conventionally, there is technology of a receiver receiving a radio wave from a plurality of senders that are distributed, and executing predetermined processing corresponding to one sender among the plurality of senders.

Nevertheless, with the conventional technology, a plurality of senders is disposed so that the reception areas of the radio wave are not overlap in order to prevent the receiver from detecting the plurality of senders. Moreover, in order to identify the sender to be subject to the predetermined processing, a user selects the sender to be subject to the predetermined processing among the plurality of detected senders. Thus, with the conventional technology, it is a troublesome task for the receiver to identify the one sender among the plurality of senders that are distributed. Moreover, consequently, the conventional technology lacked the user-friendliness for the user to enjoy the service and the like provided as a result of executing the predetermined processing.

According to an aspect of the disclosure, an information processing apparatus which is portable, including: a zone identifying unit to identify a zone where the information processing apparatus is located; a reception status measurement unit to measure a reception status of a signal from at least one transmitter in the zone identified by the zone identifying unit; a transmitter identifying unit to identify the transmitter as a source of the signal in which the reception status corresponds to a predetermined condition; and a processing unit to execute a predetermined processing according to the transmitter identified by the transmitter identifying unit.

According to one aspect of the disclosure, when a transmitter as a source of a signal in which a reception status corresponds to a predetermined condition is detected within a zone where an information processing apparatus is located, the user may not perform operations for executing the predetermined processing since the predetermined processing according to the transmitter is automatically executed. It is thereby possible to improve the user-friendliness for the user to enjoy the service and the like provided as a result of executing the predetermined processing.

In one aspect of the disclosure, within a range of a predetermined distance from the transmitter, the transmitter transmits a signal having radiation characteristics having a greater reception intensity, or a greater rate of change of reception intensity, of a signal from the transmitter relative to a distance from the transmitter than outside the range of the predetermined distance. Moreover, the transmitter identifying unit of the information processing apparatus detects, as a predetermined condition, a transmitter corresponding to the reception status of a signal that is detected within a range of a predetermined distance from the transmitter. Consequently, as a result of the user taking along the information processing apparatus and entering a range of the predetermined distance from the transmitter, the information processing apparatus executes the predetermined processing according to the transmitter. For example, in cases where the transmitter is installed by side of an exhibition, it is ordinary performed behavior for the user to approach the exhibition for viewing the same, and the predetermined processing is executed based on such ordinary performed behavior. Thus, the user's burden of operating the information processing apparatus can be reduced.

In one aspect of the disclosure, with one value among values in the reception status of the signal that is detected within a range in the predetermined distance from the transmitter being as a threshold, the transmitter identifying unit of the information processing apparatus may identify a transmitter as a source of a signal in which the reception status of the signal is exceeding the threshold. Upon setting one value among the values of the reception status of the signal that is detected within a range from the predetermined distance from the transmitter as the threshold, it is possible to prevent to mistake to identify a transmitter by setting the threshold to a value of the reception status of the signal that is detected at a fairly close distance to the transmitter.

In one aspect of the disclosure, the transmitter identifying unit of the information processing apparatus may identify a transmitter as a source of a signal in which the reception status of the signal corresponds to the predetermined condition for a predetermined period. Since the reception status of a signal is easily affected and changed due to the surrounding environment, it is possible to prevent to mistake to identify a transmitter by identifying the transmitter as a source of a signal in which the reception status of the signal corresponds to the predetermined condition for the predetermined period.

In one aspect of the disclosure, the zone identifying unit of the information processing apparatus may identify the zone where the information processing apparatus is located based on the reception status of the signal from the transmitter. It is thereby possible to cause the zone identifying unit and the transmitter identifying unit partially share the hardware, software and the like that are used for the processing, and the configuration of the information processing apparatus can be simplified.

In one aspect of the disclosure, the zone identifying unit of the information processing apparatus may identify one zone, among a plurality of zones, where the information processing apparatus is located. As a result of identifying one zone among a plurality of zones, the number of transmitters to be processed can be narrowed down, and the load of the information processing apparatus can be reduced. Moreover, since the transmitters in a zone other than the identified zone will no longer be a processing target, even if the reception status of the signal from a transmitter in a zone other than the identified zone corresponds to the predetermined condition, that transmitter will not be identified, and the transmitters can be identified accurately.

In one aspect of the disclosure, the information processing apparatus further includes, with each of a plurality of zones at least one transmitter is installed in, a storage unit may store association of the reception intensity or the rate of change of the reception intensity of the signal from each of a plurality of transmitters installed in the plurality of zones, with each of the plurality of zones, and the zone identifying unit may identify the zone where the information processing apparatus is located from the reception intensity or the rate of change of the reception intensity of the signal from the plurality of transmitters, and the association retained by the storage unit. As a result of using the association of the reception intensity or the rate of change of the reception intensity of the signal from each of a plurality of transmitters installed in the plurality of zones, with each of the plurality of zones, stored in the storage unit, the zone where the information processing apparatus is located can be identified accurately. Moreover, as a result of identifying the zone where the information processing apparatus is located by using a transmitter that is also a processing target of the transmitter identifying unit, this is efficient since there is no need to separately prepare a device for identifying the zone.

In one aspect of the disclosure, the information processing apparatus may further include a storage unit to stores area information on a plurality of zones, and location information acquisition unit to acquire location information indicating a location of the information processing apparatus, and the zone identifying unit may identify the zone where the information processing apparatus is located based on the area information and the location information. As a result of combining and using the location information acquired by the location information acquisition unit and the area information, the zone where the information processing apparatus is located can be identified accurately. Moreover, the location information acquisition unit may acquire the location information based on a signal from a plurality of transmitters. Consequently, the location information can also be acquired by using a transmitter that is a processing target of the transmitter identifying unit, and this is efficient since there is no need to separately prepare a device for acquiring the location information.

In one aspect of the disclosure, the transmitter may transmit a signal for use in communication with another information processing apparatus, and the information processing apparatus may further include a reception unit to receive a signal from the transmitter, and a demodulation unit to demodulate the signal received by the reception unit into an internally processable format. As signals used in communication, there are, for example, a wireless LAN signal, Bluetooth (registered trademark) signal, and soon. As a result of using a signal used for communication, the information processing apparatus can double as a communication device. Moreover, access points and the like which are widely used can be used as the transmitter. Here, the reception unit of the information processing apparatus may receive a wireless signal that is transmitted from the access point, and the reception status measurement unit may measure a radio field strength of the signal from the access point as the reception status of the signal. Consequently, the user does not need to carry the information apparatus separately from a communication device, and the convenience will improve. Moreover, since there is no need to prepare a separate device as a transmitter and an existing communication access point can be used, facility investment can be reduced.

In one mode of this disclosure, the zone identifying unit of the information processing apparatus may activate the reception status measurement unit when it identifies the zone where the information processing apparatus is located. Consequently, the activation time of the reception status measurement unit can be controlled, and the power consumption can be reduced by that much.

In one aspect of the disclosure, the information processing apparatus may further include an audio output unit to output an audio signal from an audio output device, and, as the predetermined processing, the processing unit may cause the audio output unit to output audio data corresponding to the transmitter identified by the transmitter identifying unit. Consequently, information can be provided to the user through audio. In particular, this is extremely helpful in cases where the user is a visually impaired person.

In one aspect of the disclosure, the information processing apparatus may further include a display processing unit to display image data on a display device, and, as the predetermined processing, the processing unit may cause the display processing unit to display image data corresponding to the transmitter identified by the transmitter identifying unit. Information can thereby be provided to the user visually.

Moreover, another aspect of the disclosure is an information processing apparatus including a reception status measurement unit to measurement a reception status of a signal from at least one transmitter, a transmitter identifying unit to identify the transmitter as a source of the signal in which the reception status corresponds to a predetermined condition, and a processing unit to execute a predetermined processing according to the transmitter identified by the transmitter identifying unit. When a transmitter as the sender of a signal in which a reception status corresponds to a predetermined condition is detected, the user may not perform operations for executing the predetermined processing since the predetermined processing according to the transmitter is automatically executed, and the user-friendliness is thereby improved.

As another aspect of the disclosure, the information processing apparatus may further include a storage unit to store identifying information of the transmitter, and the transmitter identifying unit may identify the transmitter when the identifying information of the transmitter as the source of the signal in which the reception status corresponds to the predetermined condition is stored in the storage unit. Consequently, when the reception status of a signal from a transmitter in which the identifying information is not stored in the storage unit corresponds to the predetermined condition, the predetermined processing is not executed, and it is possible to limit the target to be subject to the predetermined processing.

In addition, an aspect of the disclosure may also be an aspect where the method, system, information processing apparatus or program is recorded on a computer-readable recording medium or other devices or machines. Here, a computer-readable recording medium and the like refers to a recording medium which electrically, magnetically, optically, mechanically, or through chemical effect, accumulates information such as data and programs, and which can be read by a computer and the like.

### BRIEF DESCRIPTION OF THE DRAWINGS

FIG. 1 shows an example non-limiting floor plan of the art museum;

FIG. 2 shows an example non-limiting floor plan of the exhibition room that accommodates the audio commentary;

FIG. 3 shows an example non-limiting external view of the game device;

FIG. 4 shows an example non-limiting block diagram of the internal configuration of the game device;

FIG. 5 shows an example non-limiting memory map of the main memory of the game device;

FIG. 6 shows an example non-limiting the relationship of the distance from the AP as the source of the signal, and the radio field strength of the signal from the AP;

FIG. 7 shows an example non-limiting area identification database;

FIG. 8 shows an example non-limiting flowchart of the area identification program;

FIG. 9A shows an example non-limiting flowchart illustrating the processing to be executed by the AP identification program;

FIG. 9B shows an example non-limiting flowchart illustrating the processing to be executed by the AP identification program.

### DETAILED DESCRIPTION OF NON-LIMITING EXAMPLE EMBODIMENTS

### First Embodiment

The first embodiment aims to provide an information processing system, an information processing method, an information processing apparatus, and a tangible recording medium recording an information processing program capable of improving the user-friendliness for the user to enjoy the service and the like provided by the processing that is executed according to the identified transmitter.

In the first embodiment, explained is an information processing system that is used in a building, a structure or within a partitioned property including a plurality of mutually partitioned zones.

In the ensuing explanation, the building, structure or partitioned property where the information processing system is used are hereinafter referred to as the target area. The information processing system includes at least one transmitter that is installed within the target area, and an information processing apparatus capable of receiving signals transmitted from the transmitter. The transmitter is installed in at least one zone within the target area.

The target area is, for example, an art museum, event site, shopping center, or the like. A zone is a space that is physically partitioned with a wall or a partition, or a space that is virtually partitioned on a map, and is, for example, a room, store, booth, or the like. The transmitter installed in the zone transmits, within a range of a predetermined distance from the transmitter, a signal with radiation characteristics having a greater reception intensity, or a greater rate of change of reception intensity, of a signal from the transmitter relative to a distance from the transmitter than outside the range of the predetermined distance. This is signal is, for example, a wireless LAN signal, audio signal, an RFID signal, a Bluetooth (registered trademark) signal, or the like.

The information processing apparatus is a portable terminal capable of receiving signals transmitted from the transmitter and is, for example, a portable game device, PDA, mobile phone terminal, smart phone, PHS, dedicated portable terminal, or the like.

With the information processing system, the information processing apparatus identifies and detects the zone where it is located. The zones include a zone where a transmitter is installed and a zone where a transmitter is not installed. For example, the information processing apparatus identifies the zone where it is currently located, and determines whether a transmitter is installed in the zone. The information processing apparatus executes, for example, any processing among (1) to (3) below in order to identify the zone where it is currently located.

(1) The information processing apparatus acquires the current location information including coordinates and the like, and identifies the zone where it is currently located based on the current location information and the area information of the target area. The area information is, for example, a map of the target area. As methods for acquiring the current location information, there are, for example, a method of receiving a signal from a wireless LAN access point installed within the target area and obtaining the current location information with three-point measurement from reception intensity of the signal, and a method of obtaining the current location information from a GPS signal that is received from a GPS satellite.

(2) Let it be assumed that a plurality of transmitters are installed within the target area. The information processing apparatus retains a database in which, for example, the respective zones and the reception intensity of the signals from the respective transmitters in the respective zones, which are measured in advance, are associated, and identifies the zone where it is currently located based on the reception intensity of the signal from the respective transmitters and the database.

(3) The information processing apparatus identifies the zone where it is currently located form the identification number of the zone that is input by the user. For example, the identification number of the zone may be posted at the entrance of the respective zones, or displayed on the map of the target area. Regardless of which method of (1) to (3) above the information processing apparatus uses in order to identify the zone where it is currently located, whether a transmitter is installed in the zone where the information processing apparatus is currently located can be determined by the storage unit retaining in advance the information of the zones where a transmitter is installed.

Next, in the information processing system, the information processing apparatus identifies the zone where it is currently located, and, upon determining that a transmitter is installed in the identified zone, activates the reception status measurement unit which measures the reception status of a signal from at least one transmitter installed in the zone where it is currently located. The reception status of a signal is, for example, the reception intensity of the signal, the rate of change of the reception intensity of the signal relative to the distance from the transmitter as the source of the signal, or the like. The reception status measurement unit is hardware, software, or a combination thereof. For example, if the signal transmitted from the transmitter is a wireless LAN signal, the reception status measurement unit to be activated is both the reception unit for receiving the wireless LAN signal and software which measures the reception unit of the wireless LAN signal, or software which measures the reception status of the wireless LAN signal, or a dedicated hardware circuit which measures the reception status of the wireless LAN signal, or the like. Moreover, if the signal transmitted from the transmitter is a wireless LAN signal, the reception intensity of the signal can also be, for example, the radio field strength. Moreover, for example, if the signal transmitted from the transmitter is an audio signal, the reception status measurement unit to be activated is both the audio input unit such as a microphone and software which measures the reception status of the audio signal, or software which measures the reception status of the audio signal, or a dedicated hardware circuit which measures the reception status of the audio signal, or the like. Moreover, if the signal transmitted from the transmitter is an audio signal, the reception intensity of the signal is, for example, the SN ratio of the audio signal. Here, the audio signal includes, for example, at least a person's voice or sound.

The information processing apparatus identifies the transmitter as the source of the signal corresponding to a predetermined condition among at least one transmitter that is installed in the zone where it is currently located based on the measurement results of the reception status of the signal by the reception status measurement unit. For example, as one of the radiation characteristics of a signal from a transmitter, there is a characteristic where, within a range of a predetermined distance from the transmitter, the rate of change of the strength of the signal relative to the distance from the transmitter will be greater than outside the range of the predetermined distance. If the signal transmitted from the transmitter has the radiation characteristics described above, the predetermined condition of the reception status of the signal that is used for identifying the transmitter is, for example, the reception status that is measured within the range of the predetermined distance.

Moreover, in order to identify the transmitter for example, the information processing apparatus may also measure the reception intensify of the signal or the rate of change of the reception intensity of the signal as the reception status of the signal, and identify the transmitter as the source of the signal in which the reception intensity or the rate of change of the reception intensity is greater than a predetermined threshold. When the signal transmitted from the transmitter has the characteristics described above, the predetermined threshold may also be set as follows. When the condition for identifying the transmitter is that the reception intensity of the signal is greater than a predetermined threshold, the predetermined threshold is set to a value within the measurement range of the reception intensity of the signal within a range of the predetermined distance from the transmitter. Moreover, when the condition for identifying the transmitter is that the rate of change of the reception intensity of the signal is greater than a predetermined threshold, the predetermined threshold is set to a value that is greater than the rate of change of the reception intensity of the signal within and outside the range of the predetermined distance, and to a value that is smaller than the range of change of the reception intensity of the signal within the range of the predetermined distance. Note that, in cases where a plurality of transmitters are used in the information processing system and the transmission power of the plurality of transmitters is uniform, the reception intensity of the signal may be used as a condition for identifying the transmitter. Moreover, if a plurality of transmitters is used in the information processing system and the transmission power of the plurality of transmitters is not uniform, the rate of change of the reception intensity of the signal may be used as the condition for identifying the transmitter.

The predetermined distance to become the boundary where the rate of change of the reception intensity of the signal increases is, for example, a close distance of roughly several cm to 1 m from the transmitter. Accordingly, on the assumption that the transmitters are installed at intervals that are greater than the predetermined distance, even if the information processing apparatus receives signals from a plurality of transmitters, it is possible to identify one transmitter corresponding to the reception status of the signal that is measured within the range of the predetermined distance, or one transmitter in which the reception intensity of the signal or the rate of change of the reception intensity of the signal becomes greater than a predetermined threshold. Since the predetermined distance is a close distance of roughly several cm to 1 m from the transmitter and the transmitters are normally installed father than the predetermined distance, the premise of the transmitters being installed at intervals that are greater than the predetermined distance will sufficiently work. Accordingly, the administrator of the information processing system may not pay particular attention to the spacing of the transmitter upon installing the transmitters.

Note that, even when the information processing apparatus receives a signal from the transmitter that is installed outside that zone where it is located, the information processing apparatus excludes that signal from the transmitter from the processing target. For example, the information processing apparatus retains information of the location of the transmitters installed in the respective zones, and excludes the signal for which the source is the transmitter existing outside the zone where the information processing apparatus is located from the processing target. Consequently, for example, if the transmitter as the source of the signal with the strongest reception intensity among the signals received by the information processing apparatus exists outside the zone where the information processing apparatus is located, the signals from the transmitter are excluded from the processing target. Thus, the accuracy for identifying the transmitter is improved.

When the information processing apparatus identifies the transmitter as the source of a signal in which the reception status corresponds to a predetermined condition among at least one transmitter that is installed in the zone where it is currently located, the information processing apparatus executes predetermined processing corresponding to the identified transmitter. The predetermined processing is, for example, the replay of audio data, display of text data and/or image data on the display device, unlocking of data to which is access has been locked, sending and receiving of data, execution of an application program of a game or the like, control of devices in the information processing apparatus, and so on. The control of devices in the information processing apparatus includes, for example, the control of turning the device ON and OFF.

As described above, with the first embodiment, the information processing apparatus identifies the zone where it is located among the zones in the target area, and detects that a transmitter is installed in the zone. Next, the information processing apparatus identifies the transmitter as the source of a signal in which the reception status corresponds to a predetermined condition among the transmitters installed in the zone, and executes predetermined processing according to the transmitter. As a result of a user carrying the information processing apparatus approaching the transmitter to a distance where the reception status of a signal from the transmitter corresponds to a predetermined condition, the information processing apparatus executes the predetermined processing according to the transmitter. Thus, it is possible to omit the user's operation of causing the information processing apparatus to execute the predetermined processing. Consequently, it is possible to improve the user-friendliness for the user to enjoy the service provided by the predetermined processing that is executed according to the identified transmitter.

A case where the information processing system described above is applied to an audio commentary service for visually impaired persons is now explained. The information processing system provides, for example, audio commentary regarding the touchable exhibitions within an art museum. In this example, an art museum is used as the target area, an exhibition room, hallway, lobby or the like is used as the zone, a wireless LAN access point is used as the transmitter, and a portable game device is used as the information processing apparatus. Moreover, as the method for the information processing apparatus to identify the zone where it is currently located, the method of (2) above of using the signals from the respective transmitters and the database described above is adopted. The wireless LAN access point is hereinafter simply referred to as the AP. Moreover, a visitor carrying the game device 1 is hereinafter simply referred to as a user.

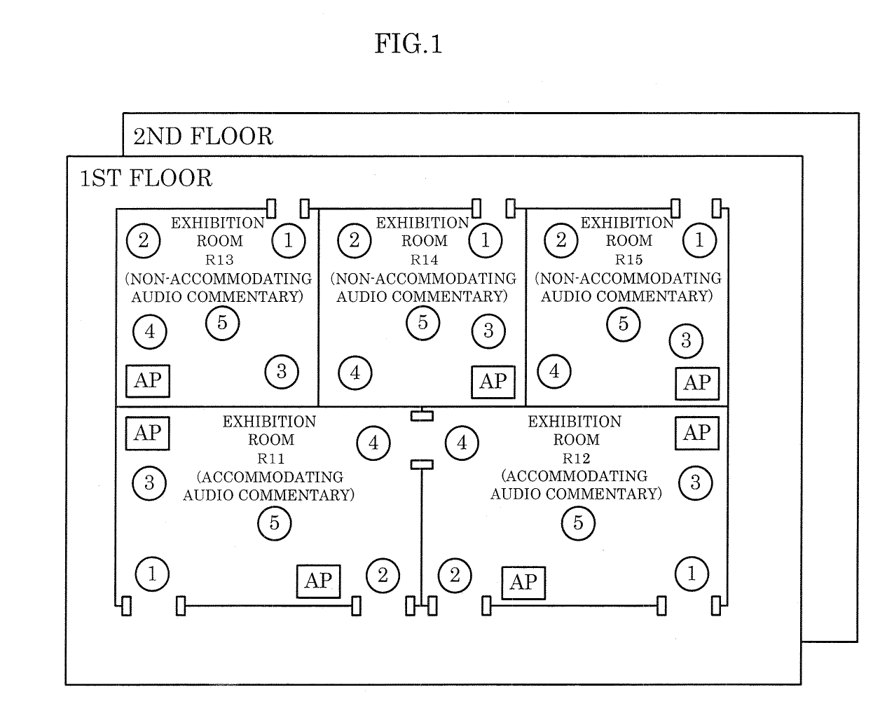

FIG. 1 is an example of a floor plan of the art museum. In FIG. 1, for the sake of convenience, the floor plan of the first floor is illustrated. However, the floor plan of the art museum exists for each floor. The first floor of the art museum includes five exhibition rooms; namely, exhibition room R11, exhibition room R12, exhibition room R13, exhibition room R14, and exhibition room R15. Among the five exhibition rooms, the exhibition rooms that accommodate the audio commentary of exhibitions are the exhibition room R11 and the exhibition room R12. The exhibition rooms that accommodate the audio commentary are the exhibition rooms where an AP is installed as the transmitter at a location corresponding to the exhibition (described in detail later). Moreover, in the first embodiment, regardless of the accommodation of the audio commentary of exhibitions, at least one AP for wireless communication is installed in the respective exhibition rooms. However, in FIG. 1, for the sake of convenience, the display of APs installed at a location corresponding to the respective exhibitions of the exhibition room that accommodates the audio commentary is omitted, and one or two wireless communication APs are illustrated in the respective exhibition rooms. The zones such as the exhibition room, hallway, and lobby in the art museum are hereinafter referred to as areas.

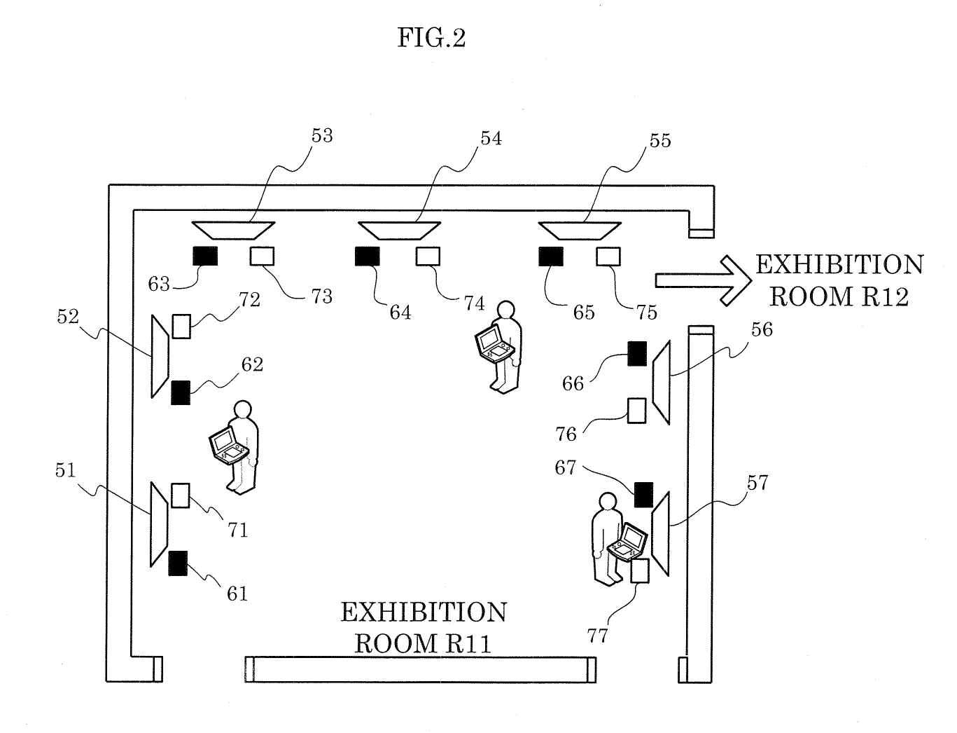

FIG. 2 is an example of the floor plan of the exhibition room R11 that accommodates the audio commentary among the five exhibition rooms illustrated in FIG. 1. The exhibition room R11 is now explained as a representative example of an exhibition room that accommodates the audio commentary.

Exhibitions 51 to 57 are displayed in the exhibition room R11. The respective exhibitions 51 to 57 are exhibitions that can be touched by visitors. Thus, visually impaired persons can also appreciate the respective exhibitions 51 to through contact. In the vicinity of the respective exhibitions 51 to 57, plates 61 to 67 marked with the identification number of the respective exhibitions 51 to 57, and APs 71 to 77 are disposed. The plates 61 to 67 are printed with the identification number of the respective exhibitions 51 to 57, and additionally printed with Braille indicating the identification number of the respective exhibitions 51 to 57 for visually impaired persons.

The APs 71 to 77 are Wi-Fi (Wireless Fidelity)-certified devices, and receive wireless LAN signals. One wireless LAN signal among those transmitted by the APs 71 to 77 is a beacon. A beacon contains SSID (Service Set Identifier) and MAC (Media Access Control) address as the identifiers of the AP. The game device 1 receives the beacon that is transmitted from the respective APs, and identifies the AP as the source of the beacon based on the SSID and MAC address contained in the beacon. Since the APs 71 to 77 are widely used wireless LAN access points, the detailed explanation of the configuration thereof is omitted.

For example, if the exhibitions 51 to 57 are paintings, the plates 61 to 67 are disposed at an area below the frame on the wall or the like where the exhibitions 51 to 57 are hung, and the APs 71 to 77 are disposed at the upper part of the wall where the exhibitions are hung. For example, if the exhibitions 51 to 57 are sculptures, the plates 61 to 67 are disposed at the front surface of the gaine of the exhibitions 51 to 57, and the APs 71 to 77 are disposed on the top face or side face of the gaine of the exhibitions 51 to 57. In either case, the plates and the APs are disposed in the vicinity of the exhibitions; for example, disposed within a range of roughly several cm to 30 cm from the exhibitions.

<Configuration of Game Device>

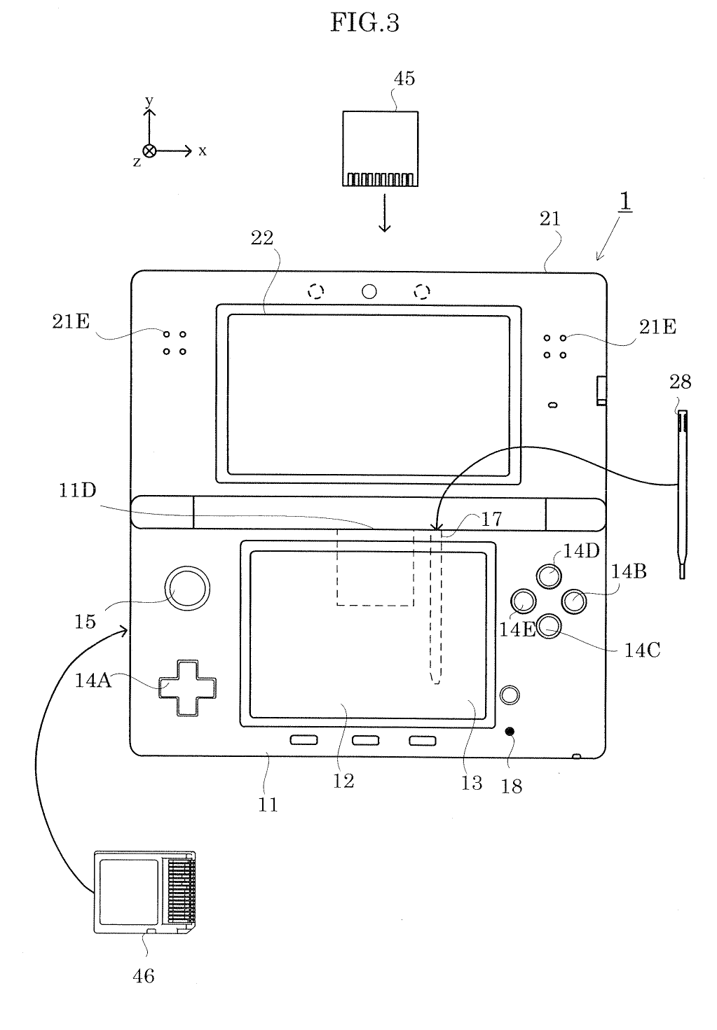

FIG. 3 is an example of an external view of the game device 1. The game device 1 includes a lower housing 11 and an upper housing 21 which are connected in an openable/closable (foldable) manner via a hinge structure.

The lower housing 11 is provided with a lower LCD (liquid crystal display device) 12, a touch panel 13, respective operation buttons 14A to 14E, an analog stick 15, an insertion slot 11D, an insertion slot 17, and a microphone hole 18.

The touch panel 13 is one of the input devices of the game device 1. The touch pen 28 that is used for inputting to the touch panel 13 is inserted into the insertion slot 17 (illustrated with a dotted line in FIG. 3), and housed in the lower housing 11. Note that the user's finger can be used in substitute for the touch pen 28.

The respective operation buttons 14A to 14E are input devices for performing predetermined inputs. The operation buttons 14A to 14E are appropriately assigned functions according to the program that is executed by the game device 1. For example, the respective operation buttons 14B to 14E are used for operations to make decisions or cancellations. The operation button 14A and the analog stick 15 are devices for instructing directions.

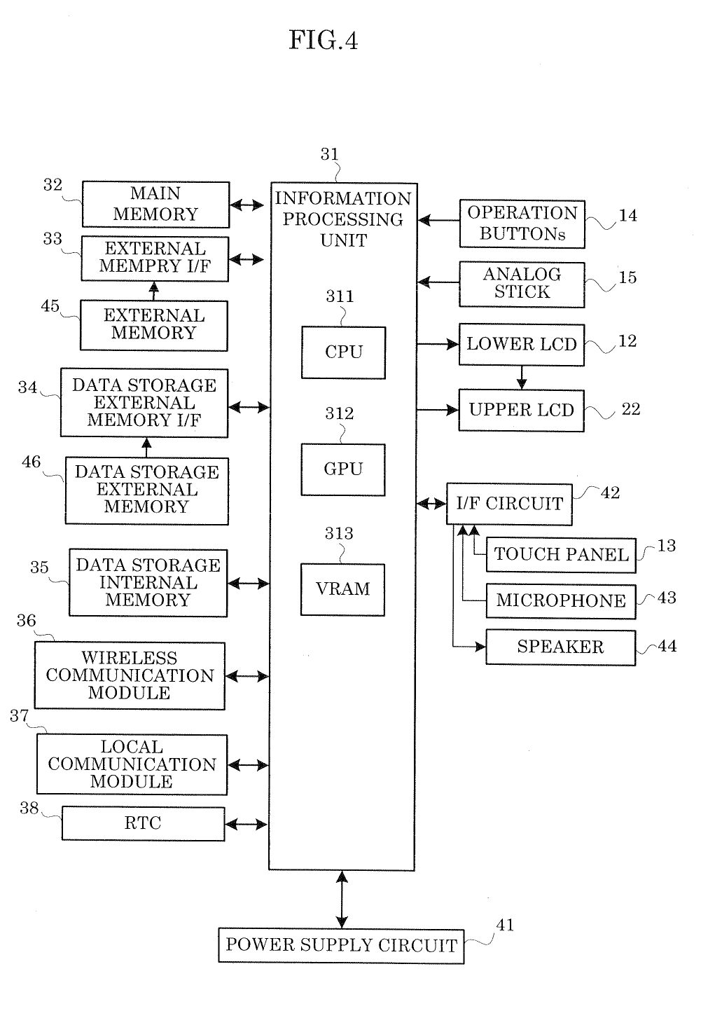

The insertion slot 11D (illustrated with a dotted line in FIG. 3) is used for inserting the external memory 45 recorded with an information program such as a game program. A microphone (refer to FIG. 4) as an audio input device described later is provided below the microphone hole 18, and the microphone detects external sound of the game device 1.

The upper housing 21 is provided with an upper LCD 22. Moreover, a speaker hole 21E is provided on either side of the upper LCD 22 in the upper housing 21. Sound from the speaker 44 described later is output from the speaker hole 21E.

FIG. 4 is a block diagram illustrating one example of the internal configuration of the game device 1. The game device 1 includes, in addition to each of the foregoing components described above, electronic components such as an information processing unit 31, a main memory 32, an external memory interface (external memory I/F) 33, a data storage external memory interface 34, a data storage internal memory 35, a wireless communication module 36, a local communication module 37, a real time clock (RTC) 38, a power circuit 41, and an interface circuit (I/F circuit) 42. These electronic components may be mounted on an electronic circuit board and housed in the lower housing 11 (or the upper housing 21).

The information processing unit 31 includes a CPU 311 for executing a predetermined program, a GPU 312 for performing image processing, and a VRAM 313. The CPU 311 executes the predetermined processing by executing the predetermined program stored in the memory (for example, the external memory 45 or the data storage internal memory 35 connected to the external memory I/F 33) in the game device 1. Note that the program to be executed by the CPU 311 of the information processing unit 31 may also be acquired from another apparatus via wireless communication with such other apparatus by using, for example, the wireless communication module 36. The GPU 312 of the information processing unit 31 generates an image according to a command from the CPU 311 of the information processing unit 31, and renders this in the VRAM 313. The image that was rendered in the VRAM 313 is output to and displayed on the upper LCD 22 and/or the lower LCD 12.

Connected to the information processing unit 31 are a main memory 32, an external memory I/F 33, a data storage external memory I/F 34, and a data storage internal memory 35. The external memory I/F 33 is an interface for detachably connecting the external memory 45. Moreover, the data storage external memory I/F 34 is an interface for detachably connecting the data storage external memory 46.

The main memory 32 is volatile storage unit that is used as the work area or buffer area of the information processing unit 31 (CPU 311). In other words, the main memory 32 is used for temporarily storing various types of data, and temporarily storing the program that is acquired from the outside (external memory 45 or another apparatus). In the first embodiment, for example, a PSRAM is used as the main memory 32.

The memory 45 is nonvolatile storage unit for storing the program to be executed by the information processing unit 31. The external memory 45 is configured, for example, from a read-only semiconductor memory. When the external memory 45 is connected to the external memory I/F 33, the information processing unit 31 read the program that is stored in the external memory 45. The predetermined processing is performed as a result of the program that is read by the information processing unit 31 being executed.

The data storage external memory 46 is a readable/writable nonvolatile memory (for instance, a NAND-type flash memory), and is used for storing predetermined data. For example, the data storage external memory 46 is an SD card. The data storage internal memory 35 is configured from a readable/writable nonvolatile memory (for instance, a NAND-type flash memory), and is used for storing predetermined data. For example, the data storage external memory 46 and the data storage internal memory 35 store the data and programs which are downloaded by way of wireless communication via the wireless communication module 36.

Connected to the information processing unit 31 are a wireless communication module 36 and a local communication module 37. The wireless communication module 36 has a function of connecting to a wireless LAN based on, for example, a system that is compliant with the IEEE802.11b/g standard. Moreover, the wireless communication module 36 receives wireless LAN signals, demodulates the wireless LAN signals into a format that is used in the game device 1, and outputs these to the information processing unit 31. The information processing unit 31 sends and receives data to and from other apparatuses via the internet by using the wireless communication module 36. Moreover, the local communication module 37 has a function of performing wireless communication with the same type of game device based on a predetermined communication system (for example, infrared communication). The information processing unit 31 sends and receives data to and from another game device of the same type by using the local communication module 37.

Connected to the information processing unit 31 are an RTC 38 and a power circuit 41. The RTC 38 measures the time and outputs the result to the information processing unit 31. The information processing unit 31 calculates the present time based on the time that is measured by the RTC 38. The power circuit 41 controls the electrical power from the power source of the game device 1 (the rechargeable battery housed in the lower housing 11), and thereby supplies electrical power to the respective components of the game device 1.

Connected to the information processing unit 31 is an I/F circuit 42. Connected to the I/F circuit 42 are a microphone 43, a speaker 44, and a touch panel 13. The microphone 43 detects the user's voice and outputs the voice signal to the I/F circuit 42. The speaker 44 amplifies the voice signal from the I/F circuit 42 with an amplifier (not illustrated), and outputs the voice. The I/F circuit 42 includes a voice control circuit for controlling the microphone 43 and the speaker 44, and a touch panel control circuit for controlling the touch panel 13. The voice control circuit performs the A/D conversion or D/A conversion to the voice signal, and converts the voice signal into voice data of a predetermined format. In the first embodiment, as the touch panel 13, a resistive touch panel is used. However, the touch panel 13 is not limited to a resistive touch panel, and, for example, a capacitance-type or arbitrary press-type touch panel may also be used. The touch panel control circuit generates touch position coordinates of the touch panel 13 of a predetermined format based on the signal from the touch panel 13, and outputs this to the information processing unit 31. The information processing unit 31 identifies the touch position where the input is made to the touch panel 13 by acquiring the touch position data.

The operation button 14 is connected to the information processing unit 31, and outputs, to the information processing unit 31, the operation data indicating the input status (whether it has been pressed) of the respective operation buttons 14A to 14E. The information processing unit 31 executes the processing according to the input that is made to the operation button 14 by acquiring the operation data from the operation button 14.

The lower LCD 12 and the upper LCD 22 are connected to the information processing unit 31. The lower LCD 12 and the upper LCD 22 display the image according to the command from the information processing unit 31 (GPU 312). The number of pixels of the lower LCD 12 is, for example, 320 dots×240 dots (horizontal×vertical). The number of pixels of the upper LCD 22 is, for example, 800 dots×240 dots (horizontal×vertical). Note that, in the first embodiment, although an LCD is being used as the display device, for example, a display device using EL (Electro Luminescence) or other display devices may also be used. Moreover, as the lower LCD 12 and the upper LCD 22, a display device having the intended resolution may also be used.

In addition to the respective components described above, the game device 1 may also include, for example, a camera, an acceleration sensor, and an angular velocity sensor.

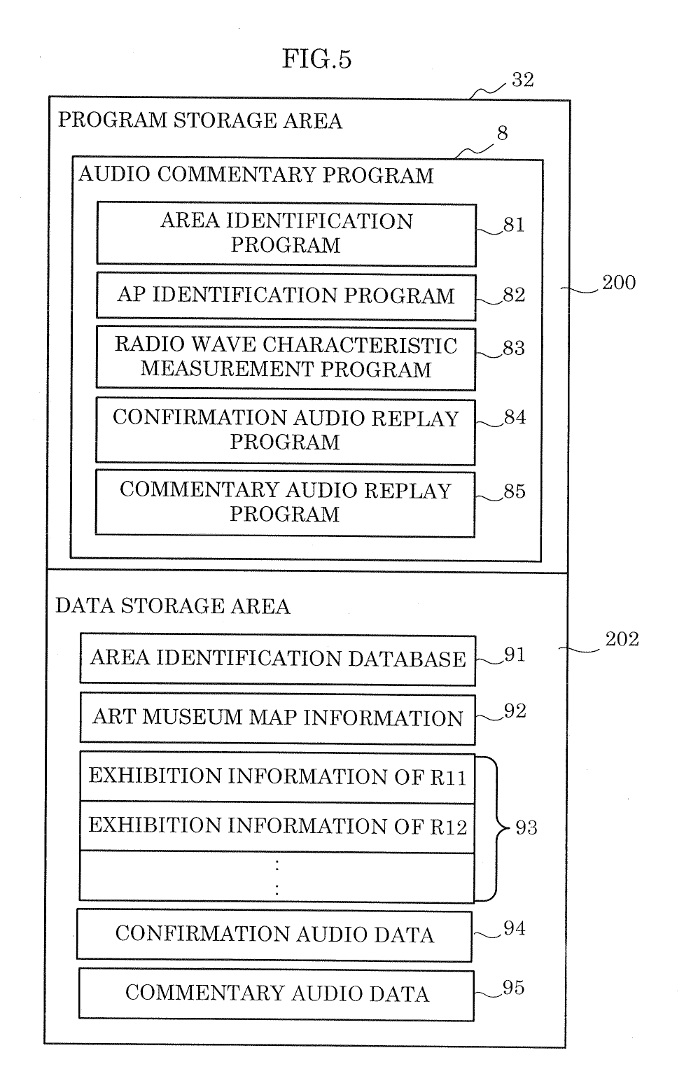

FIG. 5 is an example of the memory map of the main memory 32 of the game device 1. The memory map of the main memory 32 includes a program storage area 200, and a data storage area 202. A part of the programs and data is partially read from the external memory 45 or the data storage internal memory 35 collectively or as needed, and stored in the main memory 32. Note that FIG. 5 illustrates a part of the memory map, and the main memory 32 stores other programs and data requested for the processing in addition to the programs and data illustrated in FIG. 5. For example, sound data for outputting sounds such as sound effects and music, image data for generating a screen, sound output program, image generation display program and the like are read from the external memory 45 or the data storage internal memory 35, and stored in the data storage area 202 or the program storage area 200.

The program storage area 200 stores the audio commentary program 8. The audio commentary program 8 is a program for the audio commentary of exhibitions for visually impaired persons. The audio commentary program 8 is downloaded from a predetermined server, for example, before viewing the art museum, through the wireless communication module 36 of the game device 1, and stored in the data storage internal memory 35. However, the audio commentary program may also be stored in the data storage internal memory 35 through the external memory 45. The audio commentary program 8 includes an area identification program 81, an AP identification program 82, a radio wave characteristic measurement program 83, a confirmation audio replay program 84, and a commentary audio replay program 85.

The area identification program 81 is a program for identifying the area where the game device 1 is located among the areas such as the exhibition room, hallway, and lobby in the art museum. The area identification program 81 includes the processing (area identification processing) of identifying the area where the game device 1 is currently located based on the reception intensity of the signal from a plurality of APs installed in the art museum and the area identification database 91 (described later), and the processing of determining whether the area where the game device 1 is currently located accommodates the audio commentary of the exhibitions. Moreover, the area identification program 81 includes the processing of controlling the activation and stop of the AP identification program 82. Note that the AP signal that the game device 1 receives through the execution of the area identification program 81 is, for example, a beacon. However, without limitation to a beacon, it may be a signal which transfers data. For example, when the area where the game device 1 is currently located changes from an area that does not accommodate the audio commentary to an area that accommodates the audio commentary, the AP identification program 82 is activated though the execution of the area identification program 81. Moreover, if the area where the game device 1 is currently located changes from an area that accommodates the audio commentary to an area that does not accommodate the audio commentary, the AP identification program 82 is stopped though the execution of the area identification program 81. The area identification program 81 is an example of the zone identifying unit.

The AP identification program 82 is a program for identifying the exhibitions to be subject to the audio commentary in the area where the game device 1 is currently located. Under the circumstances where the AP identification program 82 is running, the area where the game device 1 is currently located is an area that accommodates the audio commentary identified by the area identification program 81. The AP identification program 82 includes the processing (AP identification processing, details to be described later) of identifying one AP among the APs installed in the area that accommodates the audio commentary detected by the area identification program 81, and the processing (exhibition identification processing) of identifying the exhibitions associated with the identified AP as the exhibitions to be subject to the audio commentary. The AP identification program 82 is an example of the transmitter identifying unit.

The radio wave characteristic measurement program 83 is a program for measuring the radio wave characteristics (reception status) of the AP signals that are received through the wireless communication module 36. The radio wave characteristic measurement program 83 is executed during the course of executing the processing included in the AP identification program 82. Note that the AP signal that the game device 1 receives through the execution of the radio wave characteristic measurement program 83 is, for example, a beacon. However, without limitation to a beacon, it may be a signal which transfers data. The game device 1 acquires the identifying information (SSID, MAC address, or the like) of the AP from a beacon signal or the like. The radio wave characteristic measurement program 83 is an example of the reception status measurement unit.

The confirmation audio replay program 84 is a program for causing the user of the game device 1 to confirm the identification number of the identified exhibition compatible with the audio commentary through the execution of the AP identification program 82. The confirmation audio replay program 84 includes the processing of generating audio for reading the identification number of the identified exhibition compatible with the audio commentary from the confirmation audio data 94 retained in the data storage area 202, and the processing of replaying the generated audio, and these processes are used to urge the user of the game device 1 to confirm the identification number of the exhibition compatible with the audio commentary. The commentary audio replay program 85 is a program for replaying the commentary audio data 95 of the exhibition compatible with the audio commentary retained in the data storage area 202. The commentary audio replay program 85 is an example of the processing unit.

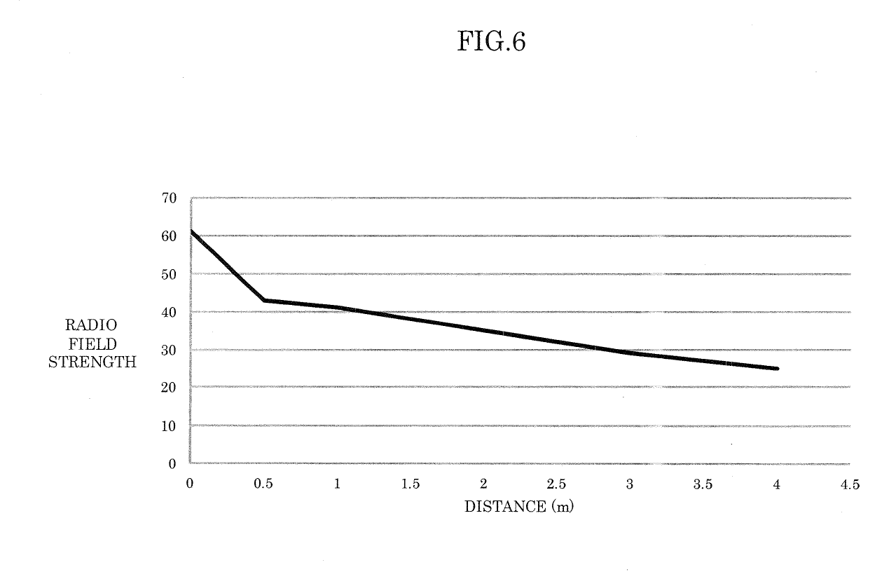

FIG. 6 is a diagram illustrating an example of the relationship of the distance from the AP as the source of the signal, and the radio field strength of the signal from the AP. In FIG. 6, the horizontal axis indicates the distance (m) from the AP as the source of the signal, and the vertical axis indicates the radio field strength of the reception signal from the AP. Note that, with the game device 1, the radio field strength of the reception signal is indicated with the numerical values of 0 to 63. However, without limitation thereof, a range of other numerical values (for example, 0 to 255 or 0 to 1023) may also be used, and the measured value may be displayed in mV/m units.

As illustrated in FIG. 6, between the distance from the AP as the source of the signal and the radio field strength of the reception signal from the AP, there is a correlation where the radio field strength of the reception signal from the AP increases as its approaches the AP as the source of the signal. Moreover, within a range of a distance of 50 cm from the AP as the source of the signal, the radio field strength of the reception signal increases steeply. More specifically, in the example illustrated in FIG. 6, with the distance of 50 cm from the AP as the boundary, the ratio (rate of change) of the amount of change of the radio field strength relative to the amount of change of the distance from the AP changes drastically. In the example illustrated in FIG. 6, the radio field strength decreases at a substantially constant inclination within the range of the distance of 50 cm from the AP, and the radio field strength also decreases at a substantially constant inclination outside the range of the distance of 50 cm from the AP. However, in comparison to outside the range of the distance of 50 cm from the AP, the inclination of the line indicating the radio field strength is greater within the range of the distance of 50 cm from the AP. In other words, the rate of change of the radio field strength increases as the distance from the AP decreases. However, the radio field strength characteristics are not limited to those which change linearly relative to the distance. For example, the radio field strength characteristics may also be such that the radio field strength attenuates at 1/r̂2 relative to the distance r outside the range of the distance of 50 cm from the AP, and drastically changes than 1/r̂2 within the range of 50 cm from the AP.

Moreover, when the user tries to touch an exhibition that is installed by being associated with the AP, the user of the game device 1 will approach the exhibition (and the AP associated with the exhibition) up to a distance where the user can touch it with his/her hand. A distance where the user can touch the exhibition is, for example, a distance of roughly 50 cm to 70 cm from the exhibition.

In light of the foregoing circumstances, the AP identification program 82 includes, as the AP identification processing, the processing of identifying the AP as the source of the signal in which the radio field strength is greater than a value (hereinafter referred to as the “predetermined threshold”) of the radio field strength that is measured within a range of a predetermined distance from the AP. A predetermined distance from the AP is a distance that is shorter than the boundary where the rate of change of the radio field strength of the reception signal relative to the distance from the AP increases drastically, and a distance in which the user can touch the AP. For example, in the case of a signal having the radio field strength characteristics as illustrated in the example of FIG. 6, the predetermined distance from the AP is a distance of 50 cm. When considering the characteristics of the wireless LAN signal as explained in FIG. 6, by identifying the AP as the sender of a signal in which the radio field strength is greater than the predetermined threshold, it is possible to detect that the game device 1 is located within a range of a predetermined distance from the identified AP. When the AP as the source of a signal in which the radio field strength is greater than the predetermined threshold is identified, it is assumed that the exhibition associated with the AP and the user of the game device 1 are located within a range of the predetermined distance (within reaching distance), and the exhibition associated with the AP is an exhibition to be subject to the user's intended audio commentary. The AP identification program 82 includes, in addition to the AP identification processing, the processing (exhibition identification processing) of identifying the exhibition that is associated with the identified AP as described above, and the exhibition that is identified by the exhibition identification processing is the target of the user's intended audio commentary. The predetermined threshold is set, for example, to the maximum value among the radio field strengths that are measured in the predetermined distance from the AP. In the case of the example illustrated in FIG. 6, for example, the predetermined threshold of the radio field strength is set to a value that is 45 or higher.

However, the radio field strength of the reception signal from the AP also changes depending on the output power of the AP. Thus, when the output power of the APs that are installed by being associated with the exhibitions is set to the same value, as the AP identification processing, it is possible to apply the processing of identifying the AP as the source of the signal in which the radio field strength is greater than the predetermined threshold described above.

Meanwhile, if the output power of the APs that are installed by being associated with the exhibitions is not uniform, as the AP identification processing, for example, applied is the processing of detecting the AP in which the attenuation rate of the radio field strength of the reception signal relative to the output power of the AP is smaller than a predetermined threshold. The threshold of the attenuation rate of the radio field strength is set to a value of the attenuation rate of the radio field strength of the reception signal that is measured within the range of the predetermined distance from the AP. For example, the threshold of the attenuation rate of the radio field strength is set to a value of the minimum attenuation rate that is measured in the predetermined distance from the AP. More specifically, the predetermined threshold of the attenuation rate is set to a value that is not greater than the attenuation rate (for example, 25%) in the predetermined distance. However, if the attenuation rate is not the same in the predetermined distance with a plurality of AP having the same output power, the smallest attenuation rate may be used as the predetermined threshold. The attenuation rate of the radio field strength of the reception signal is obtained, for example, by inquiring to the AP and acquiring the output power of the signal, and calculating the ratio of the radio field strength of the reception signal relative to the output power of the AP.

Note that the predetermined distance is not limited to 50 cm from the AP, and will change according to the target area of the information processing system, zones where the transmitters are installed, nature of the transmitters, and other matters. Otherwise, the predetermined distance may be decided using various functions according to the strength of the electromagnetic field that is radiated from the AP.

Returning to FIG. 5, the data storage area 202 retains an area identification database 91, art museum map information 92, exhibition information 93, confirmation audio data 94, and commentary audio data 95.

The art museum map information 92 is information which associated the identifying information of the area in the art museum, and the accommodation/non-accommodation of the audio commentary in the respective areas. The exhibition information 93 is information which associated the identification number of the exhibition that is installed in the area that accommodates the audio commentary and the identifying information of the AP, and is prepared for each area that accommodates the audio commentary. The confirmation audio data 94 is the audio data for causing the user to confirm the identification number of the exhibition compatible with the audio commentary identified through the execution of the AP identification program 82. For example, the confirmation audio data 94 includes audio data to be used as the materials for creating audio which reads the identification number of the exhibition compatible with the audio commentary, and audio data of the following format: “Do you wish to listen to the audio commentary of No. XXX?” The commentary audio data 95 is the audio data which reads the commentary of the exhibition, and is prepared for each exhibition compatible with the audio commentary. The commentary audio data is associated with the identification number of the exhibition.

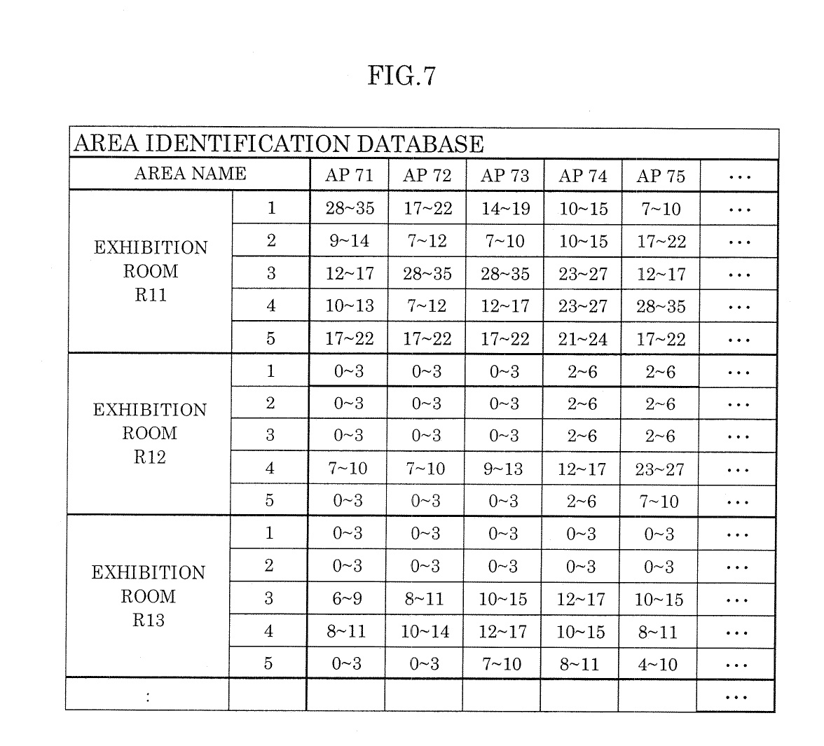

FIG. 7 is a diagram illustrating an example of the area identification database 91. The area identification database 91 is a database that is used in the processing (area identification processing), included in the area identification program 81, for identifying the area where the game device 1 is currently located. The area identification database 91 stores the range of the radio field strength of the reception signals from the respective APs obtained through a plurality of measurements at a plurality of the measurement points of radio field strengths in the respective areas. In the example illustrated in FIG. 7, it is the area identification database 91 in the example of the floor plan of the art museum illustrating in FIG. 1, and the measurement points are the locations of the circled numbers in the respective exhibition rooms in FIG. 1. Moreover, in FIG. 7, as with the example illustrated in FIG. 6, the radio field strength is indicated with numerical values of 0 to 255 that are used in the game device 1. However, the method of displaying the radio field strength is not limited to the numerical values of 0 to 255. Moreover, in substitute for the radio field strength, the attenuation rate of the radio field strength of the reception signal relative to the output power may also be used.

The area identification processing in the case of using the area identification database 91 is executed according to either method of (A) or (B) below. (A) The information processing unit 31 of the game device 1 compares the radio field strength of the respective reception signals from a plurality of APs and the respective records included in the area identification database 91. The information processing unit 31 of the game device 1 detects the records where the radio field strength of the reception signals from the respective APs coincide within the range of the radio field strength indicated in the records from the area identification database 91, and reads the records from the data storage area 202. If there is one detected record, the information processing unit 31 of the game device 1 identifies the area indicated in the record as the area where the game device 1 is currently located.

In the processing of (A) above, when a plurality of records are detected, the information processing unit 31 performs any one of the following processes (A-1) to (A-4). (A-1) The information processing unit 31 of the game device 1 determines whether the identification of the area where the game device 1 is currently located ended in a failure. (A-2) The information processing unit 31 of the game device 1 reads the execution results each time the area identification program 81 is executed; that is, reads the detected records from the data storage area 202, and stores and accumulates them as history in the data storage area 202 or a storage unit such as the data storage internal memory 35. The history of the execution results retains the transition history of the measurement points identified as where the game device 1 is currently located. When a plurality of records are detected, the information processing unit 31 of the game device 1 detects, among the plurality of records, the record of the measurement point with the highest transition count from the most recently identified measurement point based on the history of the execution results.

(A-3) The game device 1 retains the history of the execution results of the area identification program 81 as explained in (A-2). When a plurality of records are detected, the information processing unit 31 of the game device 1 detects the record with the highest count detected as the area where the game device 1 is currently located from the history of a given period in the past (for instance, 1 minute, 5 minutes, 10 minutes, or the like) from the current time.

(A-4) The game device 1 retains the map information 92 of the art museum including the path information. The path information is information of the adjacent measurement points that can be directly accessed from the respective measurement points regarding the respective measurement points. Adjacent measurement points that can be directly accessed are measurement points that can be reached without going through other measurement points. For example, the adjacent measurement points that can be directly accessed from the 4th measurement point of the exhibition room R11 illustrated in FIG. 1 are the 2nd measurement point of the exhibition room R11, the 5th measurement point of the exhibition room R11, and the 4th measurement point of the exhibition room R12. The 4th measurement point of the exhibition room R14 cannot be directly accessed from the 4th measurement point of the exhibition room R11 since there is a wall, and, therefore, is not included as an adjacent measurement point that can be directly accessed from the 4th measurement point of the exhibition room R11. When a plurality of records are detected, the information processing unit 31 of the game device 1 refers to the path information, and detects, from the plurality of records, the records of the adjacent measurement points that can be directly accessed from the measurement point that is most recently identified. If it is still not possible to identify one record, one process among (A-1) to (A-3) above may be executed.

(B) The information processing unit 31 of the game device 1 compares the radio field strength of the respective reception signals from a plurality of APs, and the respective records included in the area identification database 91. The information processing unit 31 of the game device 1 detects from the area identification database 91, a record that the number of the APs in which the radio field strength of the reception signal coincides within the range of the radio field strength indicated in the records is equal to or greater than the reference count. If one record is detected, the information processing unit 31 of the game device 1 identifies the area indicated by the record as the area where the game device 1 is currently located. When a plurality of records is detected, the information processing unit 31 of the game device 1 executes any one of the following processes (B-1) to (B-4).

(B-1) The information processing unit 31 of the game device 1 determines whether the identification of the area where the game device 1 is currently located ended in a failure. (B-2) The information processing unit 31 of the game device 1 identifies one record among the plurality of detected records based on the history of the execution results as with (A-2) above. (B-3) The information processing unit 31 of the game device 1 identifies one record among the plurality of detected records based on the history of the execution results as with (A-3) above. (B-4) The information processing unit 31 of the game device 1 detects, among the plurality of detected records, the record with the most APs that coincide with the range of the radio field strength, and identifies the area indicated by the record as the area where the game device 1 is currently located.

Based on the processing of (A-2), (A-3), (A-4), (B-2), (B-3), (B-4) above, it is possible to accurately identify the area where the game device 1 is located. Note that the identifying information (SSID, MAC address, or the like) of the AP is included in the reception signal of the beacon or the like, and the game device 1 acquires the identifying information of the AP from the reception signal.

### Operational Example

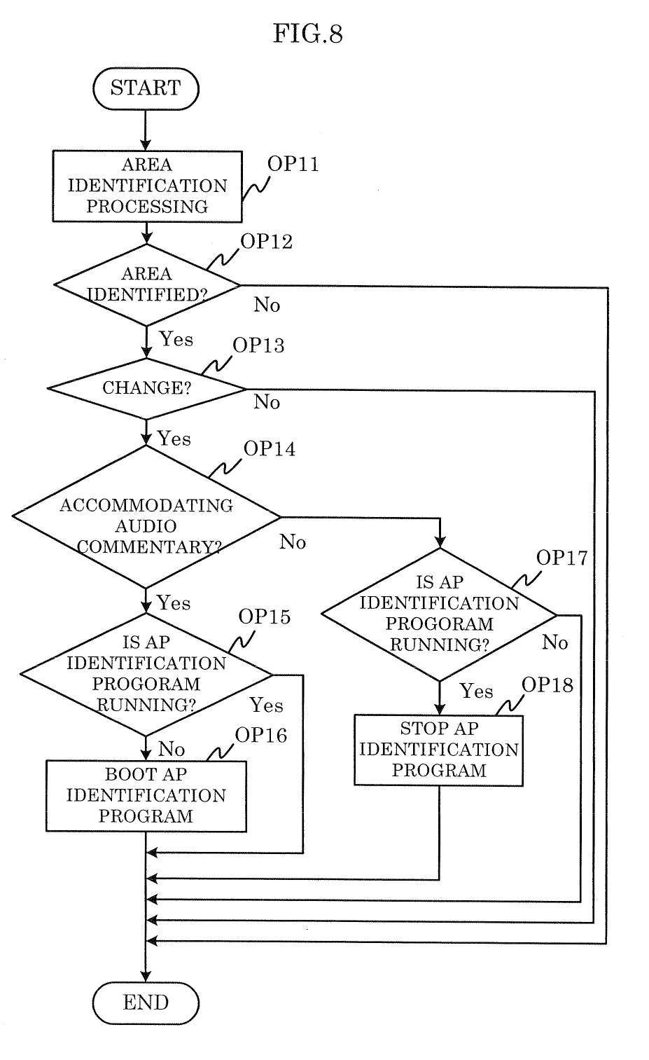

FIG. 8 is an example of the flowchart of the area identification program 81. The area identification program 81 is executed by the information processing unit 31 of the game device 1. The flowchart illustrated in FIG. 8 is started together with the activation of the area identification program 81 based on the user's input, and repeatedly executed. The area identification program 81 is stopped by the user's input, and the flowchart illustrated in FIG. 8 is also stopped.

In OP 11, the information processing unit 31 executes the area identification processing. The area identification processing is the processing of identifying the area where the game device 1 is currently located. The information processing unit 31 executes, as the area identification processing, either (A) or (B) above (one among (A-1) to (A-4) in the case of (A), and one among (B-1) to (B-4) in the case of (B)). When the execution of the area identification processing is complete, the processing proceeds to OP 12.

In the OP 12, the information processing unit 31 determines whether the area where the game device 1 is currently located is identified or not as a result of executing the area identification processing. When the area where the game device is currently located is identified (OP 12: Yes), the processing proceeds to OP 13. When the area where the game device 1 is currently located is not identified (OP 12: No), the flowchart illustrated in FIG. 8 is ended, and is repeatedly executed thereafter.

In OP 13, the information processing unit 31 determines whether the identified area; that is, the area where the game device 1 is currently located changes or not. The identified area is retained, for example, by the buffer of the main memory 32 or the pointer of the area identification database 91. When the area identified by the area identification processing changes, this indicates that the area where the game device 1 is currently located changes, and that the user of the game device 1 moves to another area. When the identified area changes (OP 13: Yes), the processing proceeds to OP 14. When the identified area does not changes (OP 13: No), the flowchart illustrated in FIG. 8 is ended, and is repeatedly executed thereafter.

In OP 14, the information processing unit 31 determines whether the area identified by referring to the art museum map information 92 is compatible with the audio commentary or not. When the identified area is compatible with the audio commentary (OP 14: Yes), the processing proceeds to OP 15. When the identified area is not compatible with the audio commentary (OP 14: No), the processing proceeds to OP 17.

In OP 15, the information processing unit 31 determines whether the AP identification program 82 is running or not. When the AP identification program 82 is running (OP 15: Yes), since it means that the user of the game device 1 moves from an area that is compatible with the audio commentary (for instance, the exhibition room R11 of FIG. 1) to another area that is compatible with the audio commentary (for instance, the exhibition room R12 of FIG. 1), the AP identification program 82 keeps running. Accordingly, in the foregoing case, the flowchart illustrated in FIG. 8 is ended, and is repeatedly executed thereafter. When the AP identification program 82 is not running (OP 15: No), the processing proceeds to OP 16.

In OP 16, since the user of the game device 1 moves from an area that is not compatible with the audio commentary (for example, the hallway) to an area that is compatible with the audio commentary (for instance, the exhibition room R11 of FIG. 1), the information processing unit 31 activates the AP identification program 82. Subsequently, the flowchart illustrated in FIG. 8 is ended, and is repeatedly executed from the beginning.

In OP 17, the information processing unit 31 determines whether the AP identification program 82 is running as in OP 15. When the AP identification program 82 is running (OP 17: Yes), the processing proceeds to OP 18. When the AP identification program 82 is not running (OP 17: No), it means that the user of the game device 1 moves from an area that is not compatible with the audio commentary (for instance, the exhibition room R13 of FIG. 1) to another area that is not compatible with the audio commentary (for example, the hallway). In the foregoing case, the flowchart illustrated in FIG. 8 is ended without activating the AP identification program 82, and is repeatedly executed from the beginning.

In the OP 18, since the user of the game device 1 moves from an area that is compatible with the audio commentary (for instance, the exhibition room R11 of FIG. 1) to an area that is not compatible with the audio commentary (for example, the hallway), the information processing unit 31 stops the AP identification program 82 that is running. Subsequently, the flowchart illustrated in FIG. 8 is ended, and is repeatedly executed from the beginning.

With the area identification program 81, the AP identification program 82 is activated when the user of the game device 1 moves from an area that is not compatible with the audio commentary to an area that is compatible with the audio commentary. Meanwhile, the AP identification program 82 is stopped when the user of the game device 1 moves from an area that is compatible with the audio commentary to an area that is not compatible with the audio commentary. In other words, the AP identification program 82 is activated when the game device 1 is located in an area that is compatible with the audio commentary. Consequently, since the AP identification program 82 is activated when needed, it is possible to reduce the power consumption of the game device 1 requested for activating the AP identification program 82.

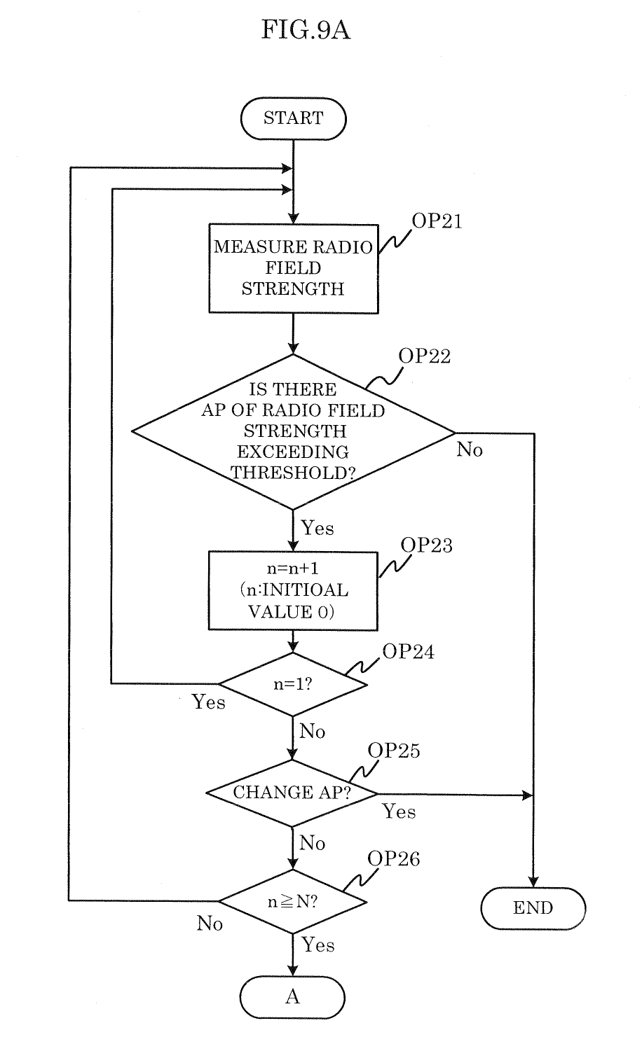

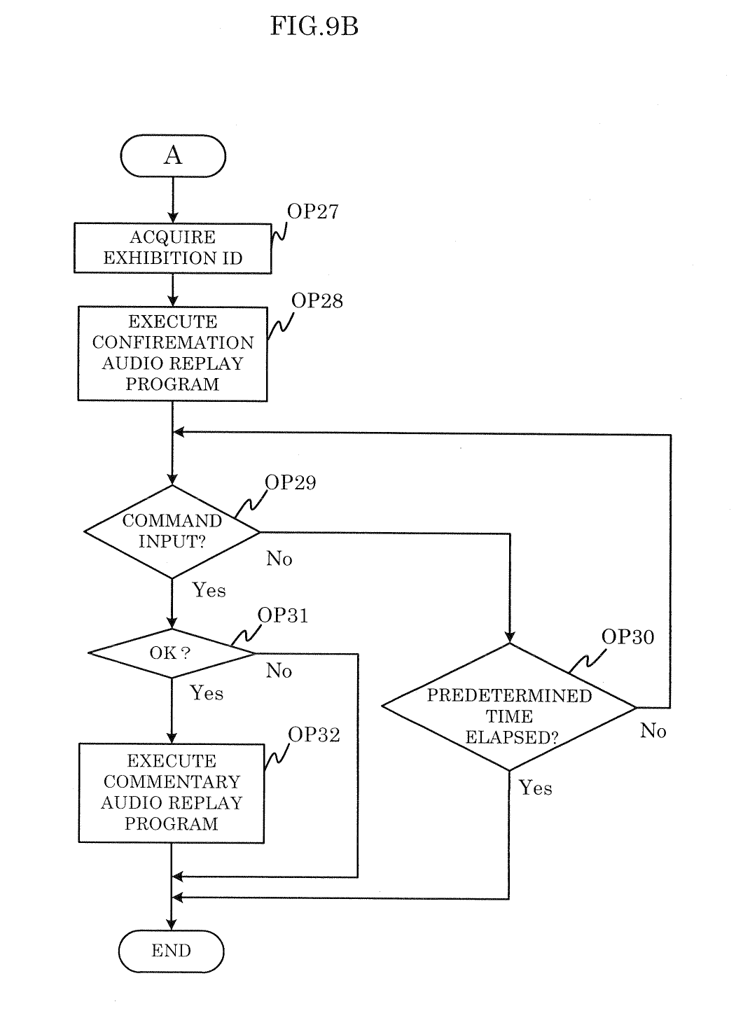

FIG. 9A and FIG. 9B are examples of flowcharts illustrating the processing to be executed by the AP identification program 82. The AP identification program 82 is executed by the information processing unit 31 of the game device 1. However, in FIG. 9A and FIG. 9B, the premise is that the output power of all APs installed in the art museum is the same, and these are flowcharts in the case of detecting an AP in which the radio field strength of the reception signal is greater than a predetermined threshold as an AP that is associated with an exhibition that is compatible with the audio commentary. The flowcharts illustrated in FIG. 9A and FIG. 9B are started together with the activation of the AP identification program 82 during the course of executing the area identification program 81, and are repeatedly executed. The AP identification program 82 is stopped during the course of executing the area identification program 81 or based on the user's input, and the flowcharts illustrated in FIG. 9A and FIG. 9B are also stopped.

In OP 21, the information processing unit 31 measures the radio field strength of the reception signal. The measurement of the radio field strength of the reception signal is performed through the execution of the radio wave characteristic measurement program 83. The processing subsequently proceeds to OP 22.

In OP 22, the information processing unit 31 determines whether there is an AP in which the radio field strength of the reception signal exceeds the threshold as a result of measuring the radio field strength. When there is an AP in which the radio field strength of the reception signal exceeds the threshold (OP 22: Yes), the processing proceeds to OP 23. When there is no AP in which the radio field strength of the reception signal exceeds the threshold (OP 22: No), the flowchart illustrated in FIG. 9A is ended, and is thereafter repeatedly executed. Note that the threshold is set, as explained in FIG. 6, to a radio field strength that is measured at a close distance where the user of the game device 1 can tough the exhibition where the AP is installed. Thus, in cases where the exhibitions with APs installed are sufficiently spaced apart, one AP will be detected as the source of the signal in which the radio field strength exceeds the threshold. Moreover, when a plurality of APs in which the radio field strength exceeds the threshold are detected, the information processing unit 31 may deem this to be an error and end the flowchart illustrated in FIG. 9A, and may be thereafter repeatedly executed.

In OP 22, if there is an AP existing outside the area where the game device 1 is located among the APs in which the radio field strength of the reception signal exceeds the threshold, the game device 1 excludes the AP existing outside the area where the game device 1 is located from the processing target. The determination on whether an AP exists outside the area where the game device 1 is located is performed, for example, based on the identifying information of the AP included in the reception signal, and the exhibition information 93.

In OP 23, the information processing unit 31 updates variable n by adding 1 to the variable n. However, the initial value of the variable n is 0. The variable n is a variable for counting the number of times that the radio field strength of the signal from the AP detected in OP 22 exceeds the threshold. The processing subsequently proceeds to OP 24.

In OP 24, the information processing unit 31 determines whether the variable n is 1 or not. When the variable n is 1 (OP 24: Yes), the processing returns to OP 21, and the processing of OP 21 to OP 23 is repeated until the variable n is no longer 1. When the variable n is not 1 (OP 24: No), the processing proceeds to OP 25.

In OP 25, the information processing unit 31 determines whether the AP detected in OP 22 changes. When the detected AP changes (OP 25: Yes), the flowchart illustrated in FIG. 9A is ended, and is repeatedly executed from the beginning. Note that the setting value of the variable n also returns to the initial value. When the detected AP does not change (OP 25: No), the processing proceeds to OP 26.

In OP 26, the information processing unit 31 determines whether the variable n is not less than the constant N or not. The constant N is, for example, a value of 3 to 5, and, in the processing of OP 26, whether the radio field strength of the AP exceeds a predetermined count (constant N) threshold is determined. When the variable n is the constant N or higher (OP 26: Yes), the processing proceeds to OP 27. When the variable n is smaller than the constant N (OP 26: No), the processing returns to OP 21, and the processing of OP 21 to OP 26 is repeated until the variable n becomes greater than the constant N. Note that, in the foregoing case, the value of the variable n is retained.

In OP 27, the information processing unit 31 acquires, from the exhibition information 93, the identification number of the exhibition that is associated with an AP in which the radio field strength exceeded the threshold a constant N times or more. The exhibition becomes an exhibition to be subject to the audio commentary. The processing subsequently proceeds to OP 28.

In OP 28, the information processing unit 31 executes the confirmation audio replay program 84, presents the identification number of the exhibition to be subject to the audio commentary to the user, and urges confirmation. Note that, here, the identification number of the exhibition to be subject to the audio commentary may be displayed on the upper LCD 22 of the game device 1. The user presses, for example, the operation button 14E of the game device 1 if the identification number of the exhibition that is presented by the game device 1 coincides with the identification number of the exhibition for which that user wishes to listen to the audio commentary. The user presses the operation button 14C of the game device 1 if the identification number of the exhibition that is presented by the game device 1 does not coincide with the identification number of the exhibition for which that user wishes to listen to the audio commentary. The processing subsequently proceeds to OP 29.

In OP 29, the information processing unit 31 determines whether the user makes an input or not. When there is an input from the user (OP 29: Yes), the processing proceeds to OP 31. When there is no input from the user (OP 29: No), the processing proceeds to OP 30.

In OP 30, the information processing unit 31 determines whether a predetermined time (for example, 1 to 3 minutes) elapses without any input from the user after presenting to the user the identification number of the exhibition for which that user wishes to listen to the audio commentary (after the processing of OP 28). When a predetermined time elapses (OP 30: Yes), the flowchart illustrated in FIG. 9B is ended, and is thereafter repeatedly executed from OP 21 (variable n returns to the initial value). When a predetermined time does not elapse (OP 30: No), the processing returns to OP 29, and the processing of OP 29 to OP 30 is repeated until there is an input from the user of the game device 1, or until a predetermined time elapses.

In OP 31, the information processing unit 31 determines whether the user's input is for acknowledging the presented identification number of the exhibition. When the presented identification number of the exhibition is acknowledged (OP 31: Yes), the exhibition to be subject to the audio commentary is confirmed, and the processing proceeds to OP 32. When the presented identification number of the exhibition is denied (OP 31: No), the flowchart illustrated in FIG. 9B is ended, and is repeatedly executed from the beginning (variable n returns to the initial value).

In OP 32, the information processing unit 31 executes the commentary audio replay program, and replays the commentary audio data of the exhibition to be subject to the audio commentary. When the replay of the commentary audio data is ended, the flowchart illustrated in FIG. 9B is ended, and is repeatedly executed from the beginning (variable n returns to the initial value). Moreover, when the user makes an input for pause during the replay of the commentary audio data, the replay of the commentary audio data is stopped, the flowchart illustrated in FIG. 9B is ended, and is repeatedly executed from the beginning (variable n returns to the initial value).

As with the flowcharts illustrated in FIG. 9A and FIG. 9B, upon detecting an AP as the source of a signal in which the radio field strength of the reception signal exceeds the threshold as the AP that is associated with the exhibition to be subject to the audio commentary, the erroneous detection of the AP can be prevented by setting the threshold to an appropriate value. An appropriate value of the threshold is, for example, a radio field strength that is measured within a range of a distance that the user can touch the (AP associated with the) exhibition. Moreover, when the threshold is set to a value that is closest to the maximum radio field strength that is measured within a range of a distance that the user can touch the (AP associated with the) exhibition, the erroneous detection of the AP can be prevented even in cases where the exhibitions (and associated APs) are spaced at a reachable distance.

### Operation and Effect of First Embodiment

In the first embodiment, the game device 1 identifies the AP as the sender of the signal in which the reception status corresponds to a predetermined condition, and identifies the exhibition that is associated with the AP as the target of audio commentary. Moreover, in the first embodiment, as the signals that are transmitted from the APs, adopted are signals having a characteristic in that, within a range of a predetermined distance from the AP, the rate of change of the radio field strength of the reception signal relative to the distance from the AP is greater than outside the range of the predetermined distance. Accordingly, in the first embodiment, the AP as the source of the signal of the radio field strength that is measured within a range of a predetermined distance from the AP or of a rate of change of the radio field strength relative to the distance from the AP is detected as the AP as the source of the signal in which the reception status corresponds to a predetermined condition. The predetermined distance is a reachable distance to the AP. Consequently, as a result of the user of the game device 1 merely moving within a reachable distance to the AP that is associated with the exhibition, the game device 1 can identify the exhibition to be subject to the audio commentary and the audio commentary is thereby started. Thus, the user of the game device 1 can use the audio commentary with fewer operations, and the user-friendliness is improved. In particular, visually impaired persons need to touch the plate disposed in the vicinity of the exhibition in order to acquire the identification number of the exhibition to confirm the Braille, and the user-friendliness is high and the user's burden is low.

When newly introducing the information processing system of the first embodiment, there is no need to newly introduce special equipment, and existing APs can be used. Thus, installation costs can be reduced. Moreover, since it will suffice if the AP is installed in the vicinity of the exhibition, there is no need to change the placement of the existing exhibition in order to introduce the information processing of the first embodiment, nor is it necessary to configure the APs based on a special setting. Thus, the information processing system of the first embodiment can be introduced easily.

Moreover, in the first embodiment, after the area where the game device 1 is located is identified, the AP that is associated with the exhibition to be subject to the audio commentary in the area is identified. For example, if the AP that is associated with the exhibition to be subject to the audio commentary in the area is identified without performing the processing of identifying the area where the game device 1 is located, there is a possibility that the signals to be received by the game device 1 may become excessive, and the load of the game device 1 will increase. In the first embodiment, as a result of foremost identifying the area where the game device 1 is located, the number of target APs is narrowed down, and by subsequently identifying the AP that is associated with the exhibition to be subject to the audio commentary, the processing load of the game device 1 is inhibited. Moreover, as a result of foremost identifying the area where the game device 1 is located, even if the reception intensity of a signal from an AP outside the area where the game device 1 is located is the strongest, the AP can be excluded from the processing target. Thus, the accuracy of identifying the AP that is associated with the exhibition to be subject to the audio commentary will improve.

Moreover, with the first embodiment, in the processing (area identification processing) of identifying the area where the game device 1 is located, the area identification database 91 is used. It is thereby possible to accurately identify the area where the game device 1 is located. Moreover, in the area identification processing, units such as GPS for acquiring other location information can also be used. In the first embodiment, the radio field strength from the AP of the wireless LAN is used in the area identification processing, and it is thereby possible to reduce the hardware to be used, and reduce the production cost of the game device 1.

Moreover, in the first embodiment, the game device 1 activates the AP identification program 82 when it is located in an area that is compatible with the audio commentary. Consequently, since the AP identification program 82 is not activated when the game device 1 is located in an area that is not compatible with the audio commentary, it is possible to reduce the power consumption by that much.

The game device 1 of the first embodiment includes a wireless communication module 36, and the game device 1 can therefore be operated as an AP of the wireless LAN. Accordingly, the game device 1 can be used as the AP that is installed by being associated with the exhibition in the first embodiment. In the foregoing case, since the game device 1 is a portable device, it can be easily installed at the location corresponding to the exhibition.

According to the first embodiment, it is possible to improve the user-friendliness for the user to enjoy the service and the like provided by the processing that is executed according to the identified transmitter.

### Modified Example 1

The information processing system can also be applied, for example, to a service of providing data of characters that appear in a film. With this service, data of the characters appearing in the film may be provided to the game device of users who came to the theater to watch the film. In the foregoing case, APs are installed at predetermined locations within the theater, and the user can receive the provision of data of characters by carrying the game device close to the AP within a predetermined distance. The predetermined distance is, for example, as with the first embodiment, a distance where the user of the game device can touch the AP, and, for example, is a distance of roughly 50 cm from the AP. This service is realized by one of the following.

(i) When the APs installed in the theater are used as the transmitters, and the game device is used as the information processing apparatus:

In the foregoing case, the game device has previously downloaded an information processing program before the arrival of the spectators, and retains the identifying information (SSID, MAC address) of the APs installed in the theater, and data concerning the characters. However, the data of characters is locked in the initial setting, and the user of the game device is unable to access the data. When the game device is carried by the user close to an AP installed in the theater within a predetermined distance, based on the execution of the information processing program, it detects that the reception signal from the AP registered with the identifying information corresponds to predetermined characteristics. The predetermined characteristics of the reception signal are the same as the first embodiment, and the processing of detecting that the reception signal from the AP corresponds to the predetermined characteristics is the same as the processing based on the execution of the AP identification program 82 of the first embodiment. When it is detected that the reception signal from the AP registered with the identifying information corresponds to predetermined characteristics, the game device unlocks the data of the character, and enables the user to access the same. Note that, the configuration of the game device in the foregoing case is in accordance with the configuration of the game device in the first embodiment.

(ii) When the game device is used as the transmitter, and the AP installed in the theater is used as the information processing apparatus (when the game device has a transmitter function):

In the foregoing case, the AP installed in the theater has previous downloaded an information processing program, and retains data of the characters. When the AP installed in the theater detects that the user carried the game device close to itself within a predetermined distance, based on the execution of the information processing program, it detects that the reception signal from the game device corresponds to predetermined characteristics as in the processing that is performed through the execution of the AP identification program 82 in the first embodiment. When it is detected that the reception signal from the game device coincides with the predetermined characteristics, the AP installed in the theater sends the data of the characters to the game device. Note that, in the foregoing case, the data of characters can also be provided on the condition that a predetermined game program has been installed in the game device.

As described in (i) and (ii) above, since the data of characters is provided when the game device is carried close to the AP installed in the theater within a predetermined distance and the reception signal coincides with the predetermined characteristics, it is possible to provide the data of characters to the users who came to the theater and watched the film. In other words, it is possible to prevent a user from wrongfully acquiring the data of characters by merely coming near the theater without watching the film.

In addition to the foregoing service, in the same manner as (i) above, the information processing system may also be applied to a stamp rally event. For example, the participants carry the game device and visit a plurality of designated train stations and collect stamp data in each train station. Here, in each of the designated stations, AP are installed at predetermined locations outside the ticket gate. The game device has previously downloaded a stamp rally program, and retains the identifying information (SSID, MAC address) of the AP that are installed outside the ticket gate of the respective stations used for the stamp rally, and the stamp data in the respective stations. However, in the initial setting, the stamp data in the respective stations is locked, and cannot be accessed by the user.

The game device determines that an AP has been previously registered based on the SSID and MAC address included in the reception signal from the AP that is installed in the stations used for the stamp rally. In addition, when the reception signal from the AP corresponds to predetermined characteristics, the game device unlocks the stamp data of the stations where the AP is installed to allow access thereof to the user.

The setting of the predetermined characteristics of the reception signal from the AP may be changed depending on the installation site of the AP. For example, if the AP is installed at a location that is relatively close to the ticket gate, the signal will also reach the game devices inside the ticket gate. Thus, the predetermined characteristics are set to a value of the radio field strength of a reception signal that is measured in a reachable distance to the AP or the rate of change of the radio field strength as in the first embodiment.

Moreover, for example, when the AP is installed at a location where the radio wave cannot be received unless it is outside the ticket gate, the predetermined characteristics may be set to a value of the radio field strength of a reception signal that is measured in a distance of roughly several m from the AP or the rate of change of the radio field strength.

(Others)

The foregoing explanation used a case of performing the processing of the audio commentary program 8 using the game device 1, but at least a part of the processing steps in the audio commentary program 8 may be performed in another device. For example, when the game device 1 is to communicate with another device (for example, a server or another game device), the processing steps in the audio commentary program 8 may be executed through coordination of the game device 1 and the other device. As one example, a device that is separate from the game device 1 may execute a part or all of the processing of the area identification program 81, the AP identification program 82, the confirmation audio replay program 84, and the commentary audio replay program 85. Moreover, as one example, the area identification database 91, the map information 92, the exhibition information 93, the confirmation audio data 94, and the commentary audio data 95 may be distributed and retained in one storage apparatus or a plurality of storage apparatuses on a network that is separate from the game device 1. Accordingly, as a result of performing at least a part of the processing steps in the audio commentary program 8 in another device, the same processing as the audio commentary program 8 is enabled. Accordingly, the processing in the audio commentary program may be executed through the coordination of one processor or among a plurality of processors included in the information processing system that is configured from at least one information processing apparatus. Moreover, in this embodiment, the processing of the flowcharts is performed as a result of the information processing unit 31 of the game device 1 executing a predetermined program, but a part or all of the processing may also be performed by a dedicated circuit of the game device 1.

Moreover, the shape of the game device 1, and the shape, quantity, arrangement and the like of the various operation button 14, analog stick 15, and touch panel 13 provided thereto are merely examples, and it goes without saying that this disclosure can be realized even with different shapes, quantities and arrangements. Moreover, the processing order, setting values, values used for determination and the like in the image processing are merely examples, and it goes without saying that this disclosure can be realized even with different orders and values.

Moreover, in addition to be supplied to the game device 1 through an external storage medium such as the external memory 45 and the data storage external memory 46, the audio commentary program 8 may also be supplied to the game device 1 through a wired or wireless communication line. Moreover, the audio commentary program 8 may also be pre-recorded in a nonvolatile storage unit within the game device 1. Note that, as the information storage medium for storing the audio commentary program 8, in addition to a nonvolatile memory, a CD-ROM, a DVD, or similar optical disc-shaped storage medium, a flexible disc, a hard disc, an optical-magnetic disc, a magnetic tape, or the like may also be used. Moreover, as the information storage medium for storing the audio commentary program 8, a volatile memory which temporarily stores the program may also be used. These external storage mediums are recording mediums that can be read by a computer and the like. For example, the various functions described above can be provided by causing a computer or the like to read and execute the program of the recording mediums.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

Moreover, it should be understood that a person skilled in the art can work an equivalent scope based on the descriptions of the embodiments and the technical common sense. In addition, it should be understood that the terms used in this specification are used in the meaning that they are normally used in this field unless otherwise noted. Accordingly, unless otherwise defined, all terminology and technical terms used in this specification have the same meaning as the terms that are generally understood by a person skilled in the art of the field to which the embodiments belong. If there is any discrepancy, this specification (including the definitions) will prevail.

What is claimed is:

1. An information processing apparatus which is portable, comprising:
a zone identifying unit to identify a zone where the information processing apparatus is located;
a reception status measurement unit to measure a reception status of a signal from at least one transmitter in the zone identified by the zone identifying unit;
a transmitter identifying unit to identify a transmitter as a source of the signal in which the reception status corresponds to a predetermined condition; and
a processing unit to execute a predetermined processing according to the transmitter identified by the transmitter identifying unit.

2. The information processing apparatus according to claim 1,
wherein, within a range of a predetermined distance from the transmitter, the transmitter transmits a signal having radiation characteristics having a greater reception intensity, or a greater rate of change of reception intensity, of a signal from the transmitter relative to a distance from the transmitter than outside the range of the predetermined distance, and
wherein the predetermined condition is the reception status of a signal detected within the range of the predetermined distance from the transmitter.

3. The information processing apparatus according to claim 2,
wherein, with one value among values in the reception status of the signal detected within a range in the predetermined distance from the transmitter being as a threshold, the transmitter identifying unit identifies a transmitter as a source of a signal in which the reception status of the signal is exceeding the threshold.

4. The information processing apparatus according to claim 1,
wherein the transmitter identifying unit identifies a transmitter as a source of a signal in which the reception status of the signal corresponds to the predetermined condition for a predetermined period.

5. The information processing apparatus according to claim 1,
wherein the zone identifying unit identifies the zone where the information processing apparatus is located based on the reception status of the signal from the transmitter.

6. The information processing apparatus according to claim 1,
wherein the zone identifying unit identifies one zone, where the information processing apparatus is located, among a plurality of zones.

7. The information processing apparatus according to claim 6, wherein
with at least one transmitter being installed in each of a plurality of zones, a storage unit stores associations of the reception intensity or the rate of change of the reception intensity of the signal from each of a plurality of transmitters installed in the plurality of zones, with each of the plurality of zones, and
wherein
the zone identifying unit identifies the zone where the information processing apparatus is located based on the reception intensity or the rate of change of the reception intensity of the signal from the plurality of transmitters, and the association stored in the storage unit.

8. The information processing apparatus according to claim 1, further comprising:
a storage unit to store area information on a plurality of zones; and
a location information acquisition unit to acquire location information indicating a location of the information processing apparatus,
wherein the zone identifying unit identifies the zone where the information processing apparatus is located based on the area information and the location information.

9. The information processing apparatus according to claim 8, wherein the location information acquisition unit acquires the location information based on a signal from a plurality of transmitters.

10. The information processing apparatus according to claim 1, wherein the transmitter transmits a signal for use in communication with another information processing apparatus, and
the information processing apparatus further comprises:
a reception unit to receive a signal from the transmitter; and
a demodulation unit to demodulate the signal received by the reception unit into an internally processable format.

11. The information processing apparatus according to claim 10, wherein
the transmitter is an access point,
the reception unit receives a wireless signal transmitted from the access point, and
the reception status measurement unit measures a radio field strength of the signal from the access point as the reception status of the signal.

12. The information processing apparatus according to claim 1,
wherein the zone identifying unit activates the reception status measurement unit when the zone identifying unit identifies the zone where the information processing apparatus is located.

13. The information processing apparatus according to claim 1, further comprising an audio output unit to output an audio signal from an audio output device,
wherein as the predetermined processing, the processing unit causes the audio output unit to output audio data corresponding to the transmitter identified by the transmitter identifying unit.

14. The information processing apparatus according to claim 1, further comprising a display processing unit to display image data on a display device,
wherein as the predetermined processing, the processing unit causes the display processing unit to display image data corresponding to the transmitter identified by the transmitter identifying unit.

15. An information processing apparatus, comprising:
a reception status measurement unit to measure a reception status of a signal from at least one transmitter;
a transmitter identifying unit to identify a transmitter as a source of the signal in which the reception status corresponds to a predetermined condition; and
a processing unit to execute a predetermined processing according to the transmitter identified by the transmitter identifying unit.

16. The information processing apparatus according to claim 15, further comprising a storage unit to store identifying information of the transmitter,
wherein the transmitter identifying unit identifies the transmitter when the identifying information of the transmitter as the source of the signal in which the reception status corresponds to the predetermined condition is stored in the storage unit.

17. An information processing system including a portable information processing apparatus, and at least one transmitter,
the system comprising:
a zone identifying unit to identify a zone where the information processing apparatus is located;
a reception status measurement unit to measure a reception status of a signal from at least one transmitter in the zone identified by the zone identifying unit;
a transmitter identifying unit to identify a transmitter as a source of the signal in which the reception status corresponds to a predetermined condition; and
a processing unit to execute a predetermined processing according to the transmitter identified by the transmitter identifying unit.

18. An information processing method executed by a portable information processing apparatus, comprising:
identifying a zone where the information processing apparatus is located;
measuring a reception status of a signal from at least one transmitter in the identified zone;
identifying a transmitter as a source of the signal in which the reception status corresponds to a predetermined condition; and
executing a predetermined processing according to the identified transmitter.

19. A tangible storage medium recording an information processing program to be executed by a computer of a portable information processing apparatus, wherein the information processing program causes the computer to function as:
a zone identifying unit to identify a zone where the information processing apparatus is located;
a reception status measurement unit to measure a reception status of a signal from at least one transmitter in the identified zone;
a transmitter identifying unit to identify the transmitter as a source of the signal in which the reception status corresponds to a predetermined condition; and
a processing unit to execute a predetermined processing according to the identified transmitter.
